(19) United States
(12) Patent Application Publication
(10) Pub. No.: US 2019/0239536 A1
(43) Pub. Date: Aug. 8, 2019

(54) Pulse atomizer and related methods

(71) Applicant: Pulse Holdings LLC, Payson, AZ (US)

(72) Inventors: James A. Rehkopf, San Rafael, CA (US); Marius Grobler, Payson, AZ (US)

(73) Assignee: Pulse Holdings LLC, Payson, AZ (US)

(21) Appl. No.: 16/350,887

(22) Filed: Jan. 29, 2019

Related U.S. Application Data
(60) Provisional application No. 62/709,870, filed on Feb. 2, 2018.

(51) Int. Cl. A23J 3/00; F26B 3/12; F26B 25/06

(52) U.S. Cl. CPC A23J 3/00; F26B 25/06; F26B 3/12

(57) ABSTRACT

The present invention generally relates to apparatuses for drying heat-sensitive protein compositions. In one aspect, the present invention is directed to a pulse resonator/atomizer for drying heat sensitive protein compositions. The pulse resonator/atomizer comprises: a rotating valve spun by a variable-speed electric motor controlled by a Variable Frequency Drive, plus an atomizer to introduce the heat sensitive protein compositions into the resonating gas stream for drying.

### FIELD OF THE INVENTION

The present invention generally relates to apparatuses for drying heat-sensitive protein compositions.

### BACKGROUND OF THE INVENTION

Heat-sensitive protein compositions (HSPC) are widely applicable in food and nutraceutical industries. For example, egg white is qualified as a multi-purpose ingredient due to its high nutritional qualities and excellent foaming and gelling properties. Many HSPCs are commercialized under liquid solution forms but dried particulate forms can be preferable as they offer longer shelf lives and enhanced ease of transport, storage, and use. In drying HSPCs, energy efficiency and product quality are the primary concerns yet achieving one concern often frustrates the purpose of the other. High-temperature drying processes can achieve the highest drying efficiencies, but they can have a detrimental effect on the functional properties of heat-sensitive proteins. For example, liquid egg whites comprise about 80% to 95% water, and the energy imparted to evaporate the water can induce protein denaturation which reduces functional properties of the egg white such as foaming and gelling properties. Similarly, high temperature drying of milk can degrade bio-activity of constituent enzymes and overall product taste.

Many HSPCs are traditionally dried by spray drying methods, which include spraying an HSPC feed via rotary atomizers or nozzles into a hot drying medium to remove moisture and provide a dried particulate form. In order to operate efficiently, spray drying must be conducted at HSPC-damaging temperatures, for example temperatures above a denaturation temperature of one or more proteins. Most spray dryers operate at temperature below denaturation temperatures, but process efficiency suffers as a result. Further, spray dryer rotary atomizers and nozzles clog easily when conveying higher viscosity or particulate-containing feeds. Spray dryers also suffer from technical difficulties, particularly due to wear on rotary atomizers and nozzles which over time reduce feed flow rate conveying accuracy and increase maintenance costs and unit down-time.

### SUMMARY OF THE INVENTION

In one aspect, the present invention is directed to a pulse atomizer/resonator for drying heat sensitive protein compositions. The pulse atomizer/resonator comprises a pulse gas resonator, and wherein the pulse resonator comprises: a rotating valve spun by a variable-speed electric motor controlled by a Variable Frequency Drive, plus an atomizer to introduce the heat sensitive protein compositions into the resonating gas stream for drying.

In another aspect, the present invention is directed to a method for producing a dried protein-containing composition. The method includes the steps of: introducing a heat-sensitive protein composition into a drying chamber, wherein the heat-sensitive protein composition comprises water and one or more proteins; drying the heat-sensitive protein composition by contacting the heat-sensitive protein composition with a pulsed gas stream of a pulse atomizer/resonator dryer, wherein the atomizer/resonator dryer comprises a pulse gas resonator comprising a rotating valve spun by a variable-speed electric motor controlled by a Variable Frequency Drive, coupled with an atomizer; controlling the drying chamber outlet temperature such that it does not substantially exceed a denaturation temperature of one or more proteins in the heat-sensitive protein composition; and recovering a dried protein-containing composition.

### BRIEF DESCRIPTIONS OF THE DRAWINGS

FIGS. 1A-F illustrate the operation of a prior art, Hemholtz-type pulse combustor with flapper valves.

FIG. 2 illustrates a schematic view of a prior art pulse combustor and atomizer.

FIG. 3A illustrates a schematic of a prior art pulse combustion spray drying system.

FIGS. 3B-C illustrate flow diagrams for prior art pulse combustion drying methods of heat-sensitive protein compositions.

FIG. 4 illustrates a schematic view of a pulse gas resonator, according to one or more embodiments of this disclosure.

### DETAILED DESCRIPTION OF THE INVENTION

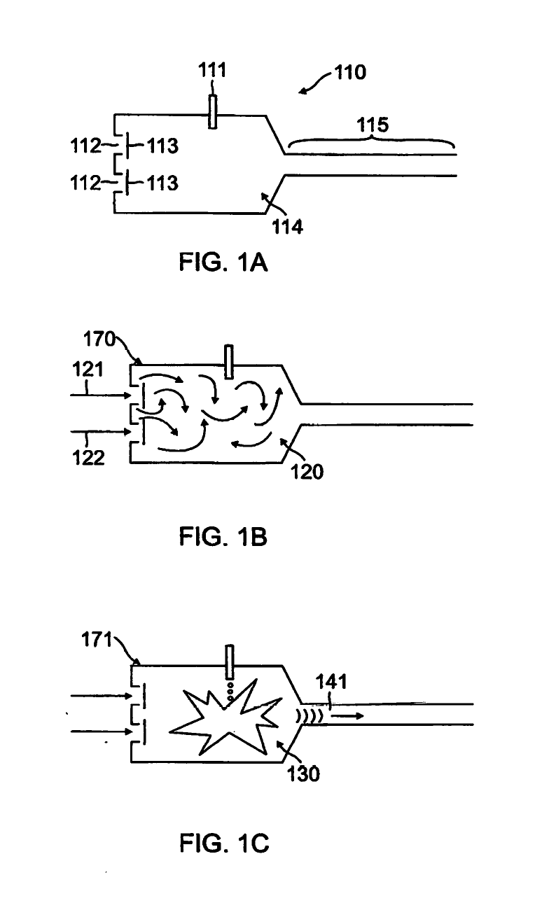

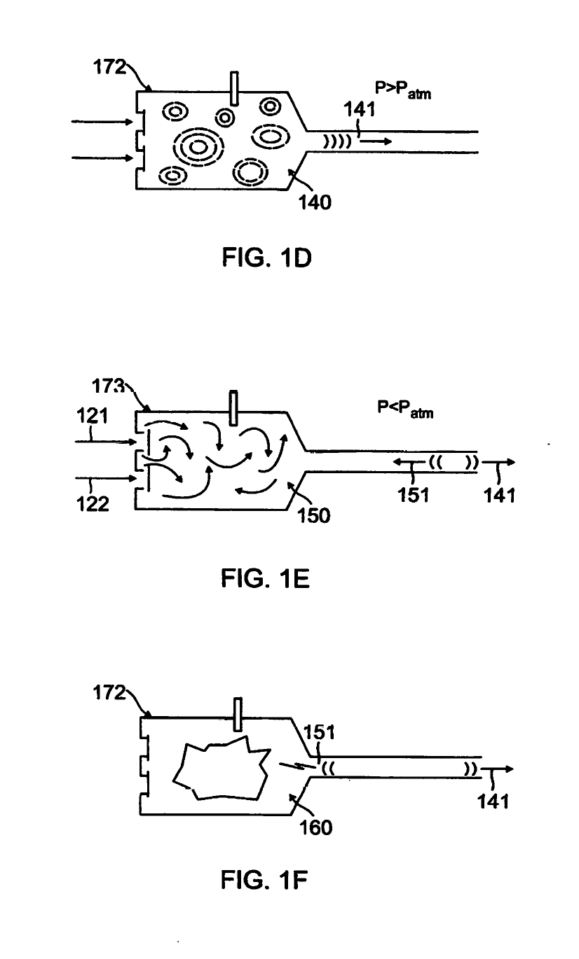

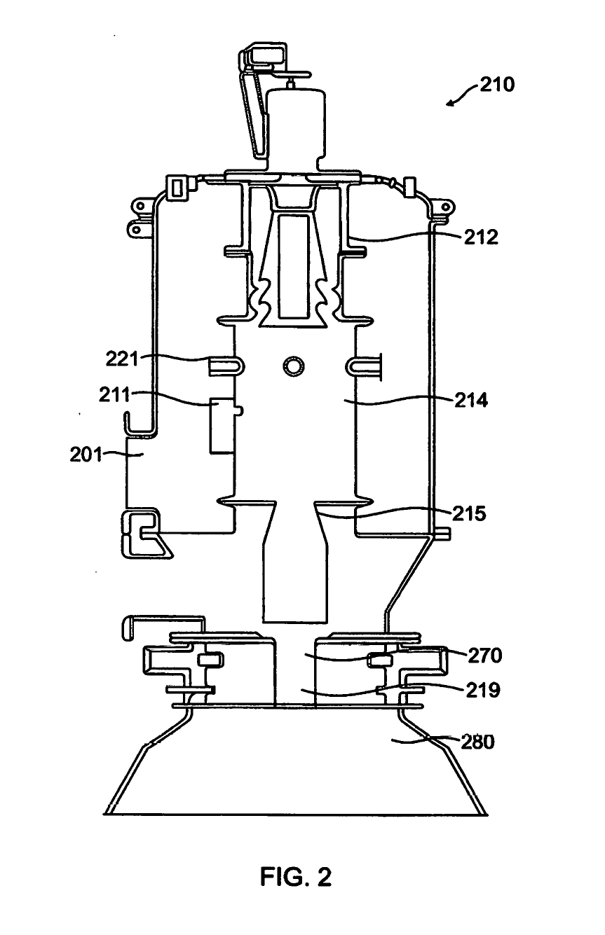

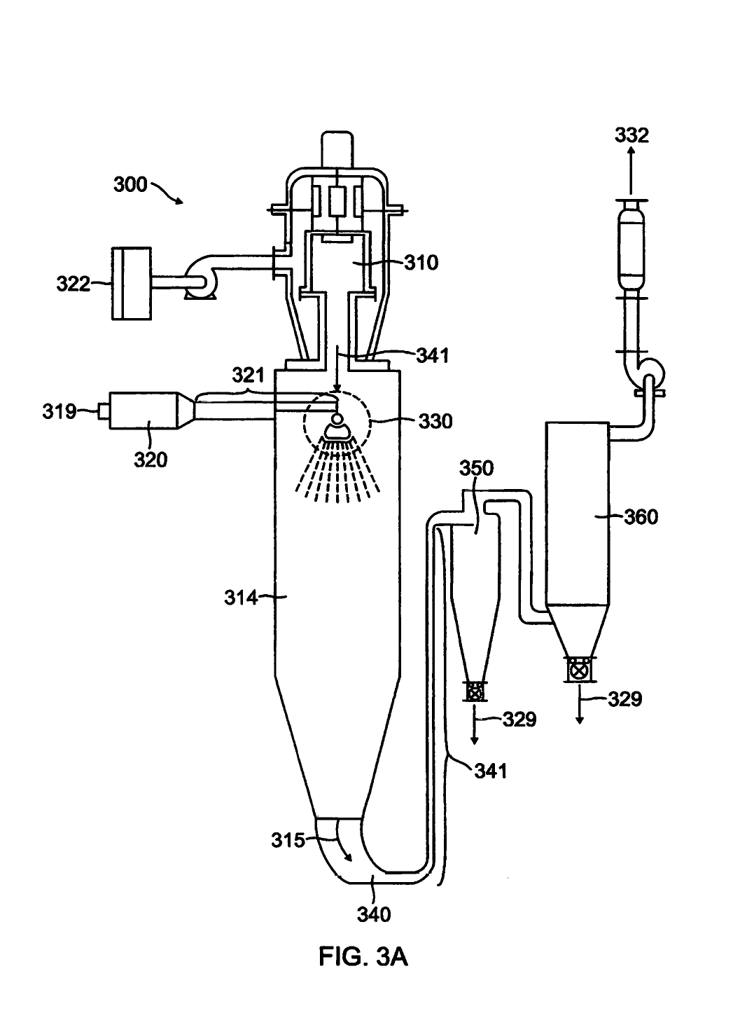

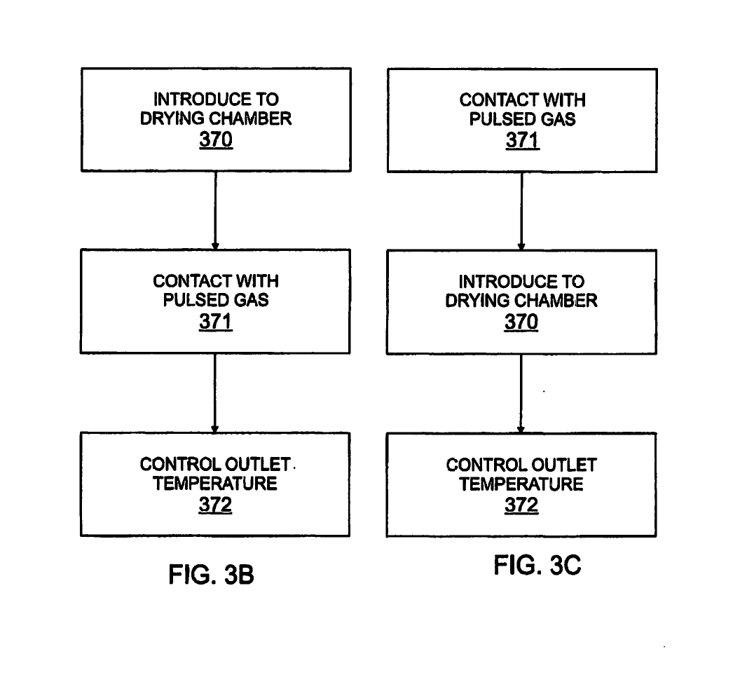

FIGS. 1A-F, FIG. 2, FIG. 3A and FIGS. 3B-C relate to prior art pulse combustors, methods of pulse combustor operation and methods of using a pulse combustor.

FIGS. 1A-F show the operating stages of a prior art Helmholtz-type pulse combustor 110 with flapper valves 113, which in some embodiments comprises a component of a PSCD system. Those of skill in the art will recognize that combustors capable of providing the operating conditions described herein to be similarly suitable. The controlling mechanism behind the operation of a pulse combustor is a complex interaction between an oscillatory combustion process and acoustic waves that are propagated from the combustor. The major function of the pulse combustor in a drying system is to supply heat for moisture evaporation and to generate large-amplitude, high frequency pressure pulsations within a drying chamber, which can each separately or in combination enhance drying rates. The strong oscillating hot flue gas jet generated by the pulse combustor can also promote dispersion of the feed.

As shown in FIGS. 1A-F, prior art pulse combustion starts when fuel 121 and combustion air 122 are drawn into the combustion chamber 114 and mixed to form a mixture 120. The mixture 120 is ignited 130 by an ignitor 111, such as a spark plug, and combusts 140 the mixture 120 explosively, resulting in a rapid pressure rise. At this moment, the rising pressure closes 171 the valves 113, sealing the air and fuel inlet ports 112 and forcing the combustion products 141 to flow out through the tailpipe 115. As the hot flue gases 141 flow out, the resulting outward momentum causes the pressure in the combustion chamber 114 to drop to the minimum so the valves 113 open, which admits fresh fuel 121 and air 122 into the combustion chamber 114. This new charge ignites itself 160 due to contact with remnants of hot flue gases 151 left in the tailpipe from the preceding cycle which reenter the combustion 114 chamber during the minimum pressure period 150. These combustion cycles repeat at a natural frequency depending on the geometry of the combustion chamber and characteristics of the tailpipe-applicator system. The expelled combustion products 141 are directed into a drying chamber (not pictured) where they contact a drying substrate, such as a HSPC.

FIG. 2 shows how a prior art pulse combustor can be used to atomize and/or dry a liquid feed. In this and other embodiments, the term “liquid” can refer to liquids, fluids, fluidized powders, slurries, suspensions, dispersions, emulsions, and the like. Air 201 is pumped into the pulse combustor 210 outer shell at a low pressure where it flows through the unidirectional air valve 212; the air enters a tuned combustion chamber 214 where fuel 221 is added; the air valve 212 closes; the fuel-air mixture is ignited by a pilot 211 and combusts or explodes creating hot air which can be pressurized to, for example, about 2 kPa above the combustion fan pressure; the hot gases rush down the tailpipe 215 toward the atomizer 270; the air valve 212 reopens and allows the next air charge to enter; the fuel valve admits fuel 221; and the mixture explodes in the hot chamber. This cycle is controllable from about 50 Hz to about 200 Hz, or in some embodiments from about 80 Hz to 110 Hz. Just above the atomizer 270, quench air is blended in to achieve desired product contact temperature; the exclusive PCS atomizer releases the liquid feed 219 into a carefully balanced gas flow, which dynamically controls atomization, drying, and particle trajectory; the atomized liquid enters a conventional tall-form drying chamber 280; downstream, the suspended powder is retrieved using any commercially acceptable means, such as a cyclone and/or bag house.

Typically, a pulse combustor may operate at frequencies that vary from 20 to 200 Hz. Pressure oscillations in the combustion chamber of the order of ±10 kPa produce velocity oscillations of about ±100 meters per second and the velocity of the gas jet exiting the tailpipe varies from about 0 meters per second to about 200 meters per second. The input power ranges from about 20 kW to about 1000 kW for commercially available pulse combustors, although other input power ranges are practicable.

FIG. 3A shows an example of a prior art pulse combustion spray drying system 300 which can be used for the techniques described herein. The system 300 comprises, among other things, a pulse combustion burner 310 and air supply 322 in fluid communication with drying chamber 314. Feed 319 is directed into the drying chamber 314 via a feed conveyer 320. The feed conveyer 320 can comprise a low-pressure, open pipe feed system, which provides the ability to process feeds having higher solids contents. This obviates the need to dilute the feed material in order to atomize it, yielding higher powder production rates and much lower processing costs per finished pound. Feed 319 contacts the pulse combustor combustion air 341 in zone 330. Zone 330 can in some embodiments be referred to as the high heat zone, wherein feed 319 is exposed to peak combustion air 341 temperatures. After the feed 319 contacts the combustion air 341, it travels out of the drying chamber 314 via a pipe or duct 340. A section of piping after the drying chamber 314, for example, piping section 341 can be cooled, to maintain the dried product 315 at a desired temperature. Similarly, a piping section 321 can be cooled such that feed 319 is not prematurely exposed to heat, or elevated above a desired initial temperature. Dried feed 315 can be processed in one or more of a cyclone 350 and bag house 360, each of which can yield final product 329. Exhaust air 332 can be expelled at the end of the system line.

As shown in FIG. 3C, prior art methods for producing a dried protein-containing composition can comprise drying a HSPC by contacting 371 the HSPC with a pulsed gas stream of a pulse combustion dryer. In some embodiments, methods further comprise introducing 370 a HSPC into a drying chamber. In other embodiments, methods can further comprise controlling 372 the drying chamber outlet temperature such that it does not substantially exceed a denaturation temperature of one or more proteins in the heat-sensitive protein composition. In some other embodiments, methods further comprise recovering a dried protein-containing composition.

Energy-efficient PCSD drying methods can effectively yield dried HSPC with low denaturation levels, even while utilizing drying gas having initial contact temperatures exceeding denaturation temperatures of proteins by 50° C., by 100° C., by 150° C., by 200° C., by 250° C., or by equal to or over 350° C. This is due to a number of factors, including short residence time of HSPCs within one or more of the high heat zone and within the PCSD drying chamber, and high oscillation of HSPCs within a drying chamber. Under such conditions, an HSPC is dried without raising the HSPC temperature above its protein denaturation temperature. Drying an HSPC without raising the HSPC temperature above its protein denaturation temperature can be achieved in some embodiments by manipulating one or more of the pulsed gas stream temperature, a residence time of the heat-sensitive protein composition within the drying chamber, pulsed gas stream pulse frequency, pulsed gas stream exit temperature, or feed flow rate. In some embodiments, an HSPC can be dried using PCSD wherein the HSPC is heated above a denaturation temperature. However, due to the extremely short residence times, the HSPC experiences only minimal denaturation.

Residence times can include less than about 10 seconds, less than about 9 seconds, less than about 8 seconds, less than about 7 seconds, less than about 6 seconds, less than about 5 seconds, less than about 4 seconds, less than about 3 seconds, less than about 2 seconds, less than about 1 second, or less than about 0.5 seconds. Residence time describes the time that a given feed particle spends in a drying chamber. In many embodiments, a PCSD drying chamber has a high heat zone in which a HSPC is only exposed to a maximum drying gas temperature for a fraction of the total residence time within the drying chamber. For example, an HSPC can be present in a high heat zone for less than about 50% of the residence time, less than about 40% of the residence time, less than about 30% of the residence time, less than about 20% of the residence time, less than about 10% of the residence time, less than about 8% of the residence time, less than about 5% of the residence time, less than about 4% of the residence time, less than about 3% of the residence time, less than about 2% of the residence time, or less than about 1% of the residence time.

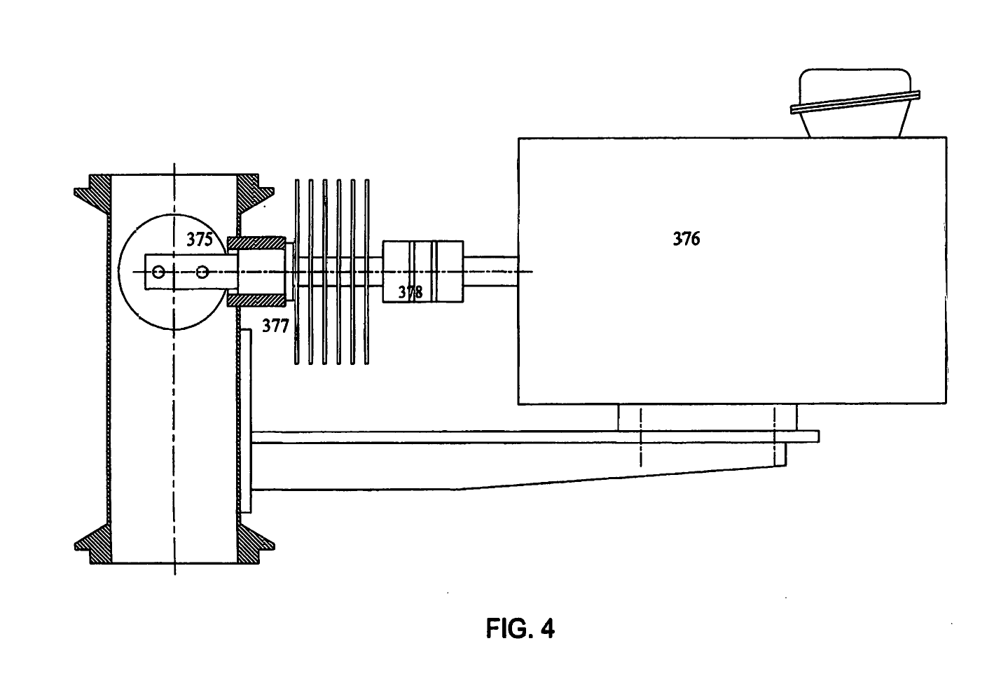

FIG. 4 shows a pulse gas resonator according to one or more embodiments of this disclosure. The pulsating mechanism features a rotating valve (375) spun by variable-speed electric motor (376) controlled by a Variable Frequency Drive (VFD) (not shown). The high temperature environment requires a special bearing (377) for the shaft, and a nonconductive shaft coupling (378). The hot air from a heater (not shown) flows downward, past the spinning valve, then to the atomizer (not shown). The rotating valve (375) pulsates the hot gas, and both the frequency and intensity of the pulsations are controllable. This device functionally replaces the combustor and tailpipe sections in a gas-fired pulse combustor.

The pulse atomizer/resonator according to one or more embodiments of this disclosure produces the same drying effects as a gas-fired pulse combustion dryer, but particular products of combustion (e.g., carbon monoxide, hydrogen cyanide, carbon dioxide) which are present in the drying gas of the gas-fired pulse combustor, are not present at all in the drying gas of the pulse atomizer resonator. In the event that the hot gas for the pulse atomizer/resonator is made in an electric heater, there are zero emissions (electric heat mode) or if made in a gas-fired heat exchanger, there low-NOx emissions (gas-fired heat exchanger mode).

Using the pulse atomizer/resonator according to one or more embodiments of this disclosure can: produce a dried HSPC comprising less than about 30% water, less than about 20% water, less than about 10% water, less than about 8% water, less than about 5% water, or less than about 1% water; produce a dried HSPC comprising less than about 10% ash, less than about 7% ash, less than about 5% ash, less than about 4% ash, less than about 3% ash, less than about 2% ash, or less than about 1% ash; produce a dried HSPC comprising less than about 10% denatured protein, less than about 8% denatured protein, less than about 6% denatured protein, less than about 4% denatured protein, less than about 2% denatured protein, less than about 1.5% denatured protein, less than about 1% denatured protein, or less than about 0.5% denatured protein.

1. A pulse atomizer/resonator for drying heat sensitive protein compositions, wherein the pulse atomizer/resonator comprises a pulse gas resonator, and wherein the pulse resonator comprises: a rotating valve spun by a variable-speed electric motor controlled by a Variable Frequency Drive, plus an atomizer to introduce the heat sensitive protein compositions into the resonating gas stream for drying.

2. A method for producing a dried protein-containing composition, the method comprising:
introducing a heat-sensitive protein composition into a drying chamber, wherein the heat-sensitive protein composition comprises water and one or more proteins;
drying the heat-sensitive protein composition by contacting the heat-sensitive protein composition with a pulsed gas stream of a pulse atomizer/resonator, wherein the pulse resonator comprises: a rotating valve spun by a variable-speed electric motor controlled by a Variable Frequency Drive, plus an atomizer to introduce the heat sensitive protein compositions into the resonating gas stream for drying;
controlling the drying chamber outlet temperature such that it does not substantially exceed a denaturation temperature of one or more proteins in the heat-sensitive protein composition; and
recovering a dried protein-containing composition.
